(19) United States
(12) Patent Application Publication
(10) Pub. No.: US 2005/0114642 A1
(43) Pub. Date: May 26, 2005

(54) System and method for managing OSS component configuration

(76) Inventors: Brett Watson-Luke, Indooroopilly (AU); David John Cooke, Tarragindi (AU)

Correspondence Address: Schwegman, Lundberg, Woessner & Kluth, P.A., P.O. Box 2938, Minneapolis, MN, 55402, US

(21) Appl. No.: 10/723,246

(22) Filed: Nov. 26, 2003

(51) Int. Cl. G06F 9/00

(52) U.S. Cl. 713/1

(57) ABSTRACT

Systems and methods manage configurations for multiple OSS components. A method starts by receiving a high level configuration that includes multiple high level configuration items. The high level configuration is translated to a low level configuration, the low level configuration including multiple low level configuration items. The low level configuration is translated to at least one OSS component specific configuration and sent to the OSS component.

### RELATED FILES

This invention is related to the following cofiled, coassigned and copending applications:
application Ser. No. ______, filed Nov. 26, 2003, entitled “SYSTEMS, METHODS AND SOFTWARE TO CONFIGURE AND SUPPORT A TELECOMMUNICATIONS SYSTEM” (Attorney Docket No.: 500.825US1);
application Ser. No. ______, filed Nov. 26, 2003, entitled “SYSTEM AND METHOD FOR HIERARCHICALLY REPRESENTING CONFIGURATION ITEMS” (Attorney Docket No.: 500.828US1);
application Ser. No. ______, filed Nov. 26, 2003, entitled “SYSTEM AND METHOD FOR CONFIGURING A GRAPHICAL USER INTERFACE BASED ON DATA TYPE” (Attorney Docket No.: 500.829US1);
application Ser. No. ______, filed Nov. 26, 2003, entitled “BIDIRECTIONAL INTERFACE FOR CONFIGURING OSS COMPONENTS” (Attorney Docket No.: 500.830US1); and
Provisional application Ser. No. ______, filed Nov. 26, 2003, entitled “SYSTEMS, METHODS AND SOFTWARE TO CONFIGURE AND SUPPORT A TELECOMMUNICATIONS SYSTEM” (Attorney Docket No.: 500.83 lPRV); all of the above which are hereby incorporated by reference.

### FIELD

The present invention related generally to telephone OSS systems, and more particularly to managing the configuration of such systems.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright® 2003, ADC Telecommunications, Inc. All Rights Reserved.

### BACKGROUND

Many of the components of a traditional OSS (operations support system) infrastructure include components that rely on internal product and service lists. Each component typically records attributes relevant to their specific domain in a proprietary format and repository. For 3G providers, the service portal and mCommerce (mobile commerce) platforms are additional domains that maintain independent product information. For many providers, creating or maintaining products is an expensive, time consuming and manual administrative task. There have been two ‘generations’ of attempts to resolve this problem.

The first generation involved selecting a system as the ‘master’ and developing scripts to automate the process of synchronizing a subset of common product attributes (e.g., name, description, identifier, active date range, pricing). This approach can be partially successful. It relies heavily, however, on a specific proprietary format. It is expensive to maintain and difficult to extend.

The second generation involved purchasing a separate system that focused on product creation and maintenance. These systems were typically sales focused, with little or no emphasis on other OSS domains. In general, the new systems made the problem worse.

In view of the above, there is a need in the art for the present invention.

### SUMMARY

The above-mentioned shortcomings, disadvantages and problems are addressed by the present invention, which will be understood by reading and studying the following specification.

One aspect of the systems and methods includes a method for managing configurations for multiple OSS components. The method starts by receiving a high level configuration that includes multiple high level configuration items. The high level configuration is translated to a low level configuration, the low level configuration including multiple low level configuration items. The low level configuration is translated to at least one OSS component specific configuration and sent to the OSS component.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a block diagram illustrating the major components of a configuration management system according to embodiments of the invention;

FIG. 2 is a block diagram illustrating an example of the use of configuration servers in the typical software product development environment according to embodiments of the invention.

FIG. 3 is a block diagram illustrating configuration abstractions, including high level, low level and OSS component database configuration abstractions according to various embodiments of the invention.

FIG. 4 is a diagram illustrating a method for managing configurations according to embodiments of the invention; and

FIG. 5 is diagram illustrating partial configuration items used in various embodiments of the invention.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

Some embodiment of the invention may be implemented using Java based system such as J2EE and JSEE. The detailed description below uses terminology, components, and functions common to Java based systems. However, the invention is not limited to such systems, and equivalents to such systems may be utilized in various embodiments. Such alternative implementation systems are included within the scope of the invention.

The following table presents definitions of terms and acronyms used in the detailed description and appendices that follow. Some of the terms are in common usage in the art, while others are specific to the present invention.

| Term | Definition |
|---|---|
| API | Application programming interface |
| CB | Convergent billing |
| CI | Commerce index |
| CM | Customer management |
| CVS | Concurrent version systems |
| DAO | Data access object |
| EJB | Enterprise Java beans |
| GPL | GNU General Public License |
| GUI | Graphical user interface |
| IDE | Integrated development environment |
| J2EE | Java 2 enterprise edition. A specification for an execution |
| | environment for enterprise applications written in Java. |
| | It includes EJB and JMS. |
| J2SE | Java 2 standard edition. |
| JAAS | Java authentication and authorisation service |
| JMS | Java messaging service |
| JRE | Java runtime-environment. |
| JVM | Java virtual machine |
| SLMS | Singl.eView Lifecycle Management Suite version 5. |
| | The program that this SAS applies to. |
| MDB | Message driven beans |
| MOM | Message oriented middleware |
| OSS | Operational support systems |
| RDBMS | Relational database management system |
| Swing | User interface toolkit that is part of J2SE |
| UI | User interface |
| W3C | World wide web consortium |
| XML | Extensible markup language |
| XML Schema | A W3C recommendation for expressing schemas |
| | (structure and valid content) of XML documents. |
| XPath | XML Path Language |

The following detailed description is, therefore, not to be taken in a limiting sense, and the scope of the present invention is defined only by the appended claims.

### Operating Environment

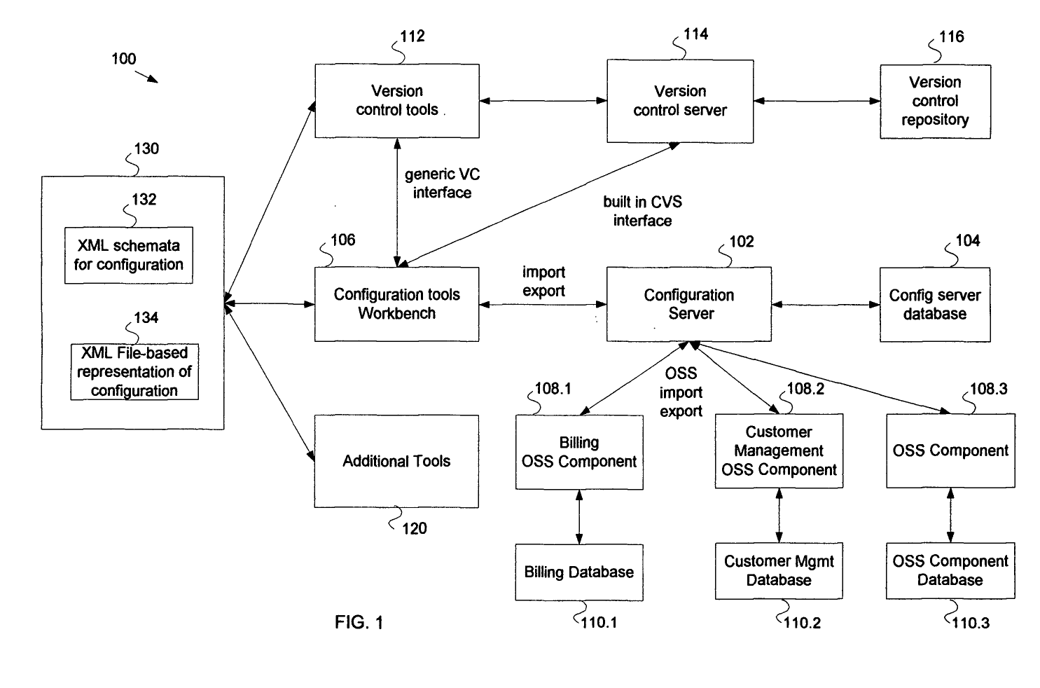

FIG. 1 is a block diagram of the major components of a hardware and software environment 100 incorporating various embodiments of the invention. The systems and methods of the present invention may be provided on a variety of hardware and software systems, including personal computers, server computers and mainframe computers and may be stored on and executed from various computer-readable media such as RAM, ROM, CD-ROM, DVD-ROM, hard disks, floppy disks, Flash Memory, Compact Flash etc. In one embodiment of the invention, environment 100 includes configuration server 102, OSS components 108, version control server 114, version control tools 112, configuration tools workbench 106, and additional tools 120.

OSS components 108 may include billing OSS component 108.1, customer management OSS component 108.2, or other OSS components such as customer relationship managers, content providers, provisioning systems and the like. Each of these OSS components 108 typically has a database 110 that is proprietary to the OSS component and stores data relevant to the tasks performed by the OSS component. For example, billing database 110.1 will contain data relevant data relevant to billing system 108.1.

APIs exist within the OSS components 108 for manipulation of their configuration. The nature of the APIs varies between these systems and depending on the configuration item, but they typically provide the ability to create, read, update and delete or obsolete configuration items in these systems. These APIs may be, however, low level—they deal with configuration in the terms of the OSS components.

The function of the configuration server 102 is to provide versions of higher-level configuration items, such as the high-level product catalog items (that span multiple OSS components), or configuration policies and composite configuration items. The configuration server 102 stores these higher level representations of configuration. It can be used to query the configuration in the OSS components, and to update it. It sends (or receives) messages to (from) OSS components 108 when configuration data is updated.

In order to develop products quickly and simply, a configuration workbench tool 106 may be provided. This GUI application can work either off a file-based representation of the product definitions, or by communicating with the configuration server 102, via its APIs. The configuration server 102 may obtain versions of configurations from version control server 114 through configuration workbench tool 106.

In order to manage the configuration effectively, version control tools 1 12 may be provided. These are applied to the file-based data/representation 130 of the configuration. These include basic tools for committing changes to configuration, viewing differences between configuration, and grouping configuration items, for version control purposes.

Additional configuration tools 120 may be provided that can extract configuration from these systems, to an external file-based form, where it may easily be manipulated using file-based tools and to load the configuration from its file-based representation back into the OSS components. These are part of the configuration tools user interface. These tools 120 interact with the OSS components via the configuration server 102.

The XML schemata 132, depicted as “interacting” with the file-based representation of the configuration 134 are the documents that define the structure of the configuration data in its file-based form. Tools and developers can use the knowledge embedded in these schemas in order to assist them in reading or processing the configuration.

Configuration APIs

In some embodiments, configuration APIs provide access to the configuration data in OSS components 108. On top of these, the configuration server 102 provides a unified API for accessing the configuration in the OSS. The API, in one example embodiment, include the following functions:
Create, read, update, delete operations.
Validation.
Searching.
Post commit notifications.
   Execution Environment

The OSS component configuration APIs may be part of the OSS component 108 itself, and may execute on any platform on which these OSS components are available. Additionally, the general configuration API may be part of the configuration server 102, and executes on the supported platforms for the configuration server 102.

OSS Import and Export

Overview

The terms import and export are used, respectively, to mean obtaining configuration data from the OSS component 108 so that it can be placed into the configuration server database 104, and to load the configuration data back into the OSS component 108. In some embodiments, requirements for these components include the following functionality:
The ability to perform export operations on groups of configuration items.
The ability to support multiple versions of OSS components.

In various embodiments, supported versions of OSS components 108 are supported by the import and export tools. Typically the system must take into account one or more of the following aspects of OSS components:
The configuration items that apply for the various versions of the product differ between releases.
The attributes of some configuration items differ between releases.
Validations and business rules that apply to various configuration items differ between releases.
The API for accessing the configuration items can vary between releases.
The transport mechanism for API calls varies between the releases. (Note that the variations may not be just between major releases. Minor releases and maintenance releases may also introduce changes of this nature.)

Import and Export Mechanisms

The import and export functionality may be met in part by functionality provided by the configuration server 102 and in part by functionality provided by the configuration tools GUI.

The configuration server 102 provides an API that allows clients to directly obtain or update a file-based, which in one example embodiment is an XML representation, of the configuration items stored in CB 122 and CM 124. It shall be understood, however, that XML is just one type of file-based form that can be used for this purpose, and that the inventive subject matter hereof is in no way limited to XML files formats. Within the configuration server 102 the import and export operations may be performed by components called publishers. These are described in the Configuration Server section herein. The GUI provides file/folder explorer views of the configuration server database 104 that allow imports and exports via menu actions, and allow items to be sent to the OSS components 108 via file copy-and-paste operations. The configuration server 102 filesystem module that provides this functionality is described in U.S. patent application Ser. No. ______, filed Nov. 26, 2003, entitled “SYSTEMS, METHODS AND SOFTWARE TO CONFIGURE AND SUPPORT A TELECOMMUNICATIONS SYSTEM” (Attorney Docket No.: 500.825US1) which has been previously incorporated by reference. An additional module may be provided that makes it easy to move configuration between repositories. This synchronisation module is described in U.S. patent application Ser. No. ______, filed Nov. 26, 2003, entitled “SYSTEMS, METHODS AND SOFTWARE TO CONFIGURE AND SUPPORT A TELECOMMUNICATIONS SYSTEM” (Attorney Docket No.: 500.825US1) which has been previously incorporated by reference. When used in conjunction with the configuration server 102 filesystem module this allows sophisticated selection of configuration to be imported/exported.

The configuration server 102 administration console also provides commands for import/export, and is described in U.S. patent application Ser. No. ______, filed Nov. 26, 2003, entitled “SYSTEMS, METHODS AND SOFTWARE TO CONFIGURE AND SUPPORT A TELECOMMUNICATIONS SYSTEM” (Attorney Docket No.: 500.825US1) which has been previously incorporated by reference.

Data Format

The import may be to an XML format, and the export may be from the XML format (for OSS components 108 and product catalog configuration).

The product catalog format may be specified as a set of related XML Schemas for the catalogs, categories, charge types and components. The product catalog schemas may be extensible.

The schema for the OSS components 108 representations may be generated from the as described in detail below.

Execution Environment

The import and export related functionality may be provided in the configuration server 102 and configuration tools UI. The execution environments of these components may be described in other sections hereof.

Version Control System and Tools

Overview

The implementation of the version control system 114 may be based on CVS. See CVS Web site: http://www.cvshome.org for documentation on CVS. The implementation consists of the following components:
CVS server software, for managing the version control repository.
CVS client software, for accessing the version control repository.
Additional support for determining the differences between configuration items in the repository and local changes and for assisting the user to merge them.

These operations may be provided in the configuration GUI by the Netbeans modules 510 for CVS. An API is provided to perform grouping operations. A visual representation of groups may be provided for usability purposes.

This is further described in U.S. patent application Ser. No. ______, filed Nov. 26, 2003, entitled “SYSTEMS, METHODS AND SOFTWARE TO CONFIGURE AND SUPPORT A TELECOMMUNICATIONS SYSTEM” (Attorney Docket No.: 500.825US1) which has been previously incorporated by reference. The following sections describe the architecture of each of these components.

CVS Server

CVS provides the core version control facilities, and the management of the version control repository in some embodiments of the invention. The software environment 100 may include software components for CVS that have been built for supported platforms.

CVS Client

There may be numerous CVS client applications and libraries available for accessing CVS. The configuration tools GUI is required to interact with the version control system, and so the CVS client facilities provided is based on the needs of the GUI. In addition a command-line client may be provided in some embodiments of the invention.

Grouping API

Support for version control operations on groups of configuration items are typically required. In order to support these operations, a grouping API may be provided, and actions may be provided in the configuration tools GUI for performing version control operations on these groups. See U.S. patent application Ser. No. ______, filed Nov. 26, 2003, entitled “SYSTEMS, METHODS AND SOFTWARE TO CONFIGURE AND SUPPORT A TELECOMMUNICATIONS SYSTEM” (Attorney Docket No.: 500.825US1) which has been previously incorporated by reference for further details.

In some embodiments, the grouping API provides Java classes for manipulating grouping information, and serialisation to XML form, and instantiation from XML form. The following facilities may be provided:
JavaBeans may be provided for representing grouping information. In some embodiments, an XML form is used for grouping information.
The ability to select items from a group in the GUI and apply CVS operations on them.
The ability to select items from a group in the GUI and import or export them from or to the OSS.

### Execution Environment

The version control server 128 can be run on any platform that CVS can be ported to. Examples of such operating systems include but are not limited to: Solaris available from Sun Microsystems, Inc., AIX available from IBM, Inc., and HP/UX available from Hewlett Packard, Inc.

In some embodiments, the version control client tools utilize a system with the JRE version 1.4.1 or later.

Configuration Server

Overview

The configuration server 102, in one example embodiment, is responsible for one or more of the following functions:
Providing a centralised location that can be queried or accessed to update configuration in the OSS.
Ensuring that configuration is changed consistently across the OSS.
Auditing changes to configuration across the OSS.
Providing notifications to interested parties when configuration changes.
Enforcing security on changes to the configuration.
Enforcing locking on configuration items.

It is possible that composite configuration and higher-level configuration will be specified for future configuration tools releases. The configuration server 102 may store these higher-level configuration items, and may propagate changes to these items to the OSS components 108 in the form of the lower level configuration items that may be used to implement the abstractions.

The configuration may include a catalog component. According to one example embodiment, the catalog component may be responsible for:
Providing transactional updates to the catalog.
Managing the persistence of the catalog.
Validating updates to the catalog.
Enforcing security on catalog updates and reads.
Auditing catalog changes.
Providing mechanisms for publishing the catalog into OSS systems.
Notifying clients when the catalog changes so they can reflect these changes.
Providing facilities for clients to search the catalog.

That is, the catalog requirements and the configuration server 102 requirements may be practically the same - the catalog merely represents a subset of the configuration data.

In some embodiments, the various components of the configuration server 102 may be implemented using a Java environment and include one or more of the following functions:
The core enterprise Java beans (EJBs) that represent configuration entities and catalog entities and that provide business interfaces to these entities.
Publishing components that push changes to the configuration data into the various OSS.
The persistent store for the configuration data and catalog (database).
The CS runs inside an EJB container. This provides:
A standardised application environment, with proven portability.
Transaction support, including two-phase commit (if required).
Choice in application servers (There may be a multitude of vendors with tested J2EE conformance. See http://java.sun.com/j2ee/compatibility.html).
Security (container managed authorization).
Distributed application server support, failover, etc for high performance and availability, for customers that require it.
Easy integration of EAI tools (via Java APIs, JMS, etc) and OSS components (via Java APIs, or the Java connector architecture).

It should be noted that XML schemas may be used for specifying the catalog data. This does not define the internal representation of the catalog data. Rather, it specifies an externalised form of the catalog data that is suitable for sharing.

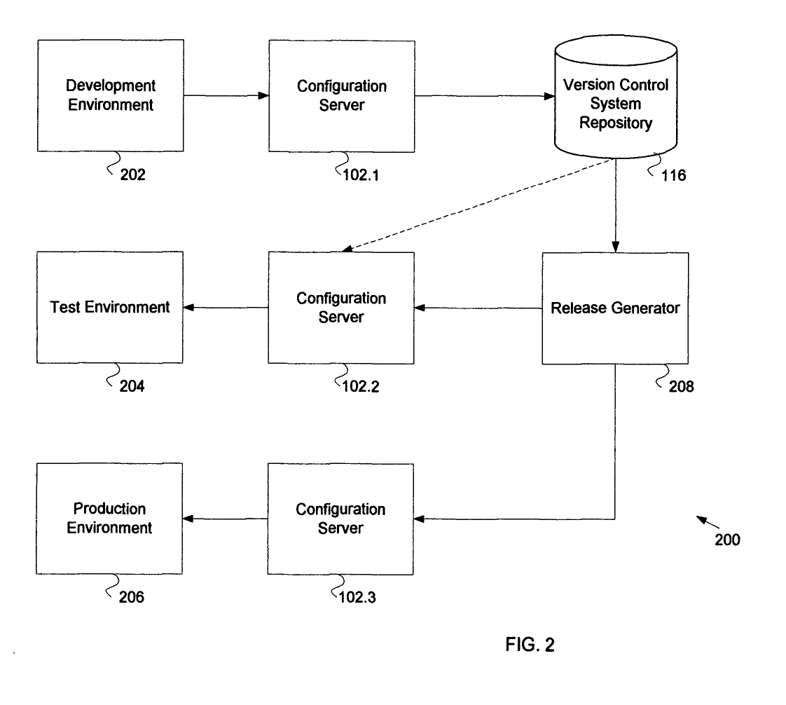

FIG. 2 provides an exemplary environment 200 according to various embodiments of the invention. Environment 200 illustrates an example of the use of configuration servers in the typical software product development environments. Exemplary environment 200 includes configuration servers 102, development environment 202, test environment 204, and production environment 206. Development environment 202 may be a set of OSS components 108 and other software development tools used by software developers to develop OSS component configurations. Typically, the development of an OSS component configuration is an iterative process where new versions of configurations are often developed as the OSS component software is created and enhanced.

Test environment 204 typically comprises a set of OSS components that are in the testing phase of a development cycle. The test environment 204 typically uses configuration versions that have been released from the development environment (possibly through an export process) that require further testing to determine whether any faults exist in the configuration.

Production environment 206 typically comprises a set of OSS components that is in actual use by a service provider for providing services to their customers, and typically requires configurations that are fairly stable and relatively fault free (as determined in the testing environment).

In some embodiments, each of these environments 202, 204 and 206 have their own configuration server 102.1, 102.2 and 102.3 respectively. However, in alternative embodiments, a single configuration server 102 may be used to provide the configuration versions required by the various environments. In additional alternative embodiments, multiple configuration servers may access a single version control repository.

In some embodiments, configuration versions are exported through a release generated 208. In these embodiments, the release generator is used to generate and export a version of a configuration that is to be used by the respective test or production environment.

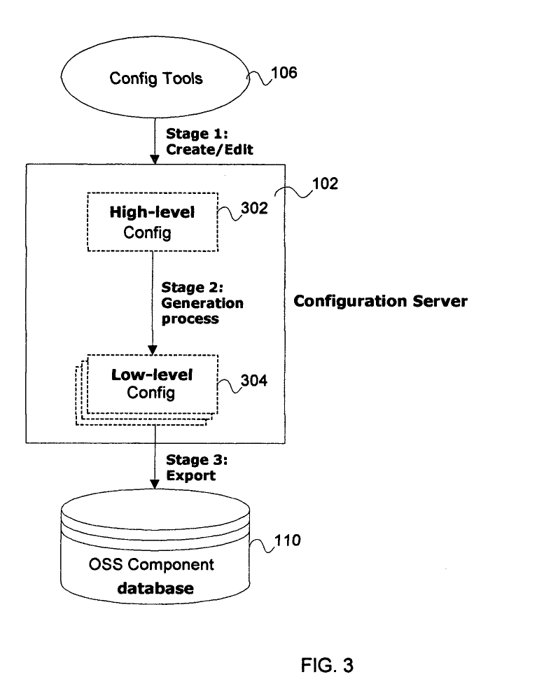

FIG. 3 is a block diagram illustrating configuration abstractions, including high level, low level and OSS component database configuration abstractions according to various embodiments of the invention. In some embodiments, configuration server 102 maintains one or more versions of high-level configuration 302. These versions may be obtained from a version control system 114. Typically the high-level configuration 302 comprises a set of one or more configuration items each of which themselves may be independently versioned. The configuration items may represent product codes, product names, product pricing, product validity dates, invoice formats, address formats and other such data. In general, high-level configuration 302 is a superset of many of the data items found in the various OSS components 108 and represent an abstraction of the various OSS components. In some embodiments, configuration tools 106 may be used to create, update, delete and otherwise manipulate one or more of the configuration items in high-level configuration 302. Configuration server 102 may then generate low-level configuration 304. Low-level configuration 304 typically comprises configuration items that are specific to a particular OSS component 108. These items are obtained by selecting relevant high-level configuration items and transforming the high-level configuration item (when necessary) to produce low-level configuration items. The transformation may include various sorts of mappings, including numeric transformation, concatenation, truncation, many-to-one, one-to-many and other types of transformations. The embodiments of the invention are not limited to any particular type of transformation. Additionally, the transformations may include filtering high-level configuration items so that the do not appear in the low-level configuration.

Additionally, the low-level configuration items may be further transformed into a format that can be exported to an OSS component 108 for updating the OSS component database 10.

In some embodiments, the high-level configuration 302 and the low-level configuration 304 may be expressed in XML (eXtensible Markup Language). Additionally, XML stylesheets may be used to perform some or all of the translation and transformation from high-level configurations to low-level configurations.

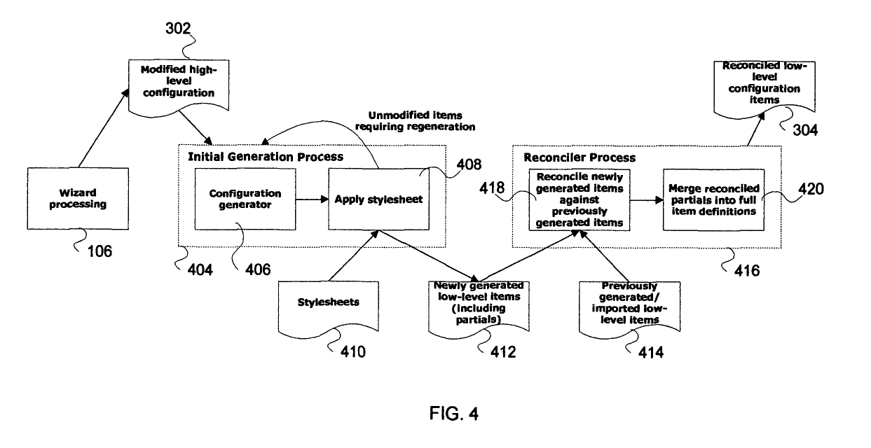

FIG. 4 is a diagram providing further details on the processes and methods that transform a high-level configuration to a low-level configuration according to some embodiments of the invention. The transformation of a high-level configuration to a low-level configuration may be referred to as “generation.”

The generation process of some embodiments of the invention will now be described. Configuration tools 106 may be used to modify high-level configuration items 302, resulting in a set of modified items being supplied to the initial generation process 404.

The initial generation process 404 distributes each modified configuration item sequentially to all available configuration generators 406. Each configuration generator 406 will process only those items that it is specifically designed to handle. Other items are ignored and may be processed by other, more suitable, configuration generators.

In particular embodiments, two configuration generators 406 are supplied with the Configuration Server 102 to provide high-level to low-level transformation for product related configuration data. One configuration generator is designed to handle the processing of base and companion products, and the other to handle pricing schemes.

It should be noted that the Configuration Server 102 of some embodiments is designed so that it is possible for the configuration users to develop and integrate other configuration generators. Additional configuration generators may be useful; for example, to handle non-XML transformations for a third party OSS component.

Each generator 406 may have a stylesheet 410 associated with it. These stylesheets 410 may be stored in the Configuration Server repository 104. As each modified high-level item is received by the appropriate configuration generator, a generate ( ) method 408 is invoked. This method applies the stylesheet 410 to the high-level configuration item, transforming it into one or more low-level configuration items 412. This transformation may also include the generation of partial item specifications.

During the transformation process some unmodified items 414 may need to be regenerated, for example if there are dependencies between the modified and unmodified configuration items.

A reconciliation process 416 takes the set of newly generated low-level items 412 and compares them with the low-level configuration previously generated 414 (or imported) for these items. Based on this comparison, the reconciliation process 416 creates any new items, updates the existing items, and deletes any items no longer required.

The reconciler process 416 is also responsible for processing partial item specifications and merging the reconciled partial items 420 into reconciled low-level configuration items 304.

Partial Item Specification

As noted above, it may be necessary as part of the generation process to generate the definition of a single low-level configuration item from multiple high-level configuration items. While in some embodiments stylesheets may be used to produce multiple output XML documents from a single XML input document, multiple input XML documents typically cannot be passed into the generation process. Consequently in some embodiments the generation process includes support for a type of configuration item known as a partial item specification (partial).

Partials, which in some embodiments are internal to a configuration server 102, may be used to improve the flexibility and efficiency of the generation process by allowing the creation of multiple incomplete definitions for the same low-level item.

As noted above, single XML document typically cannot be output from multiple input documents. Partials are generated for OSS configuration items that can be represented by multiple values. For some OSS components, including billing OSS components, these entities may include:
Derived attribute arrays, which can have thousands of rows, each represented by unique index values.
Attribute types, which may be based on SQL queries or reference types that may be enumerated to possible multiple values.
Reference Types, which can contain multiple values uniquely identified by a reference code.
   As these configuration item types may be used extensively throughout OSS components such as billing OSS components, it is desirable to be able to represent them in a configuration server.

It should be noted that partials are not part of the current core XSLT recommendations as published by W3C (World Wide Web Consortium). Thus in some embodiments, partials are provided as a solution to one of the constraints of XSLT.

Example of Use of Partials

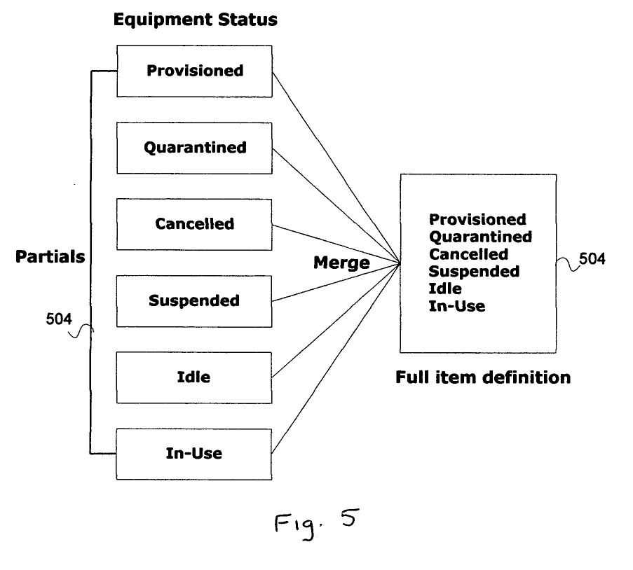

FIG. 5 provides an example of the use of partials according to particular embodiments of the invention. Assume that several high-level product definitions can result in the generation of a row in a derived attribute table (a low-level configuration item). Each row represents the initial status of an equipment type associated with a service type. Without the support of partials, a full configuration item definition (in this case, a derived attribute table) typically has to be generated for each status. Partials allow each status to be created as an incomplete part of a derived attribute definition 502, which are later combined to form a single complete definition 504 as illustrated in FIG. 5.

Reconciliation and Merge Processing

In some embodiments, partials are stored in the configuration server 102 like any other configuration item. Direct updates to partials may invoke the generation process 404 like updates to other configuration items. Partials are passed to the configuration generators. However, unlike high-level items, stylesheets do not match on the <partial> root element of all partial documents. Therefore, no high-level to low-level transformation is required. Instead, they are added to the update list, and are subsequently passed into the reconciliation process 416.

In some embodiments, during reconciliation, partials are reconciled against the previously generated items in the configuration server 102, and then combined into full definitions. This reconciliation and merge process is further described below.

Predefined or Generated

Partials may either be generated during the normal transformation of high-level configuration to low-level configuration, or predefined at some stage prior to generation.

FIG. 5 illustrates an example of how partials may be combined to form a full configuration item definition that is output to the result document of the generation process. In some embodiments, partials 502 are still regarded as complete configuration item definitions but are only used internally in the generation process 404 and reconciler process 416.

In some embodiments, a partial has its own XML representation. In these embodiments, the XML schema for a partial comprises a root <partial> element that has an output attribute referencing another configuration item. In some embodiments, the output attribute is a mandatory attribute. The item referenced is the item that the partial contributes to.

The contents of the <partial> element comprises the same schema for the referenced item, except that there are no mandatory elements or attributes.

For elements that appear more than once, an id attribute is used to identify the element uniquely. The actual value of the identifier is arbitrary, but must be consistent across all partials for a given item.

The characteristics of partials according to some embodiments are illustrated by the following example:

```
<partial type=“Partial_CBProduct” output=
  “CBProduct/EZY_Starter.xml”>
  <CBProduct>
    <productServiceTypes>
      <CBProductServiceType id=“PST-5”>
        <productServTEquipment>
          <CBProductServiceTypeEquip id=“PSTE-5-7”>
    <initialEquipmentStatusCode>INUSE</initialEquipmentStatusCode>
          </CBProductServiceTypeEquip>
        </productServTEquipment>
      </CBProductServiceType>
    </productServiceTypes>
  </CBProduct>
</partial>
```

Default Values

In some embodiments, a partial element may be predefined as a default value by using the default attribute. When the default attribute is set on a partial element, it is possible to have a duplicate partial with a different value and/or different attribute values. In some embodiments, duplicate elements and attributes must match in value, otherwise an exception is raised. When an element is specified as a default element, the entire element branch (that is, all its children) becomes part of the default definition.

Default values are typically used to ensure the successful creation of a complete item definition in situations where not all the required partial items are created during the initial generation process.

The handling of default element values during merge processing is further described below.

The Reconciler Process

In some embodiments, the reconciler process 416 is the final phase of the generation process illustrated in FIG. 4.

Low-Level Item Comparison

In some embodiments, the reconciler process 416 examines the existing low-level configuration items in the configuration server 102 and compares them with the newly generated low-level configuration items 418 output from the initial generation process 404. The process identifies (and applies) any changes required to the master copy of the low-level items stored within the configuration server repository 104.

In some embodiments, each generated low-level item records the high-level item from which it was generated, as a result, the set of existing low-level items used for the comparison may be derived based on the set of modified high-level items that were input into the initial generation process 404.

The comparison of each item may result in one of the following actions:
If the newly generated low-level configuration item already exists in the configuration server 102, it is used to update the existing item.
If the newly generated low-level configuration item does not exist in the configuration server 102, it is created.
If the existing low-level configuration item in the configuration server 102 was not (re)generated, it is considered no longer required and is deleted.
   Processing of Partial Items

The reconciler process 416 also recognises and processes partial items.

Initial Reconciliation

Initially, generated partial items are processed like all other generated configuration items and normal reconciliation processing takes place. Existing partials in the configuration server 102 are compared against newly generated partials and changed in the configuration server 102 as required. Possible outcomes are creating, updating, or deleting partials.

In some embodiments, a hard-coded partial that is inserted into the configuration server 102 before any transformations are initiated on high-level configuration items. This partial is called the master partial. The master partial does not get generated but is compared against all the generated partials to form a complete configuration item. The master partial contains all the mandatory information that is not included with other partials.

Reconciling partial items prior to merge processing generally improves efficiency because it allows unchanged partials to be ignored. This efficiency is illustrated by the following example. Assume 500 partials are generated during the initial generation process. However, only 50 of those partials have changed since the previous generation process. Once the partials have been reconciled, only the 50 that have changed need to be considered during merge processing.

Combining Partial Definitions

When partials are generated or modified as a result of the initial generation process 404, they need to be combined into full definitions by merge processing.

The basic steps of merge processing according to some embodiments are:
1. Create a list of configuration items referenced by the partial items (that were processed during reconciliation).
2. For each configuration item, retrieve all partial items for the referenced item and combine into a single definition, by the use of a Java class, PartialItem.Java.
3. Reconcile the resulting set of full item definitions in the same manner as other generated configuration items.
   Merging

In some embodiments, merge processing 420 involves merging of XML node trees (including partials) to form a single node tree, then attempting to convert the result into a configuration item. If an error occurs in this process, the error processing may occur in the same manner as if the generation process failed to create a correct definition.

The merging may be accomplished as follows:
One of the partials is selected as the basis for the combined item. Each remaining partial being designated as merge items (including the master partial).
The first merge item candidate is selected and its top-level node is compared with the top-level node of the combined item. These nodes must match, otherwise a MergeException is raised.
If they match, each child node in the merge candidate is recursively compared against the nodes in the combined item.
   Matching elements are checked to ensure their values are the same. If the values are the same, they are ignored (that is, no changes are required). If the values differ, a MergeException is raised.
In item specifications that support repeating elements (for example, a derived attribute with multiple rows), the id attribute is used to distinguish between each element. This mechanism allows matching elements to have different values, without raising a MergeException, as long as their identifiers differ.
   For elements that exist only in the merge candidate, the element and all its extended children (that is, the entire element branch) is added to the combined item.
   As with matching elements, element attributes are also checked to ensure they contain the same values. If not, a MergeException is raised. Element attributes that exist only in the merge candidate are added to the appropriate element in the combined item.
After each merge candidate has been processed, the merge attempts to convert the combined item into a fill item definition.

It should be noted that it is desirable that partial items or the transformation process is configured so as to avoid merge conflicts. Furthermore, it is desirable that any implementation that uses partials ensure that the combined partials create a full definition of a configuration item. Default values can be useful in this regard.

Handling Default Values During Merge Processing

In some embodiments, default element values may be handled by the merge process 420 as follows:
With no existing element, the entire element (including children) is merged into the merge document according to normal merge processing (described above).
With an existing element in the merge document, it is merged according to the following rules:
   If the existing element is not a default element, and the new element is a default element, the new element will be ignored; that is, the existing element will be used.
   If the existing element is a default element, and the new element is not a default element, the new element will overwrite the existing element.
   If the existing element is not a default element, and the new element is not a default element, the new element will be processed according to standard non-default merge processing.
   If the existing element is a default element, and the new element is a default element, the new element will be ignored; that is, the first default will apply.

It should be noted that in some embodiments, partials may create a single low-level entity based on what is present in the configuration server 102 at the time of the reconciliation process 416. If a low-level item created by the partials is modified in an OSS component such as a billing component and a user does a commit that triggers the reconciliation process on those partials, the OSS component entity is overwritten.

If information needs to be modified in an OSS component and retained, the master partial should be updated to include this new information. Doing this may ensure that the changes made in the OSS component are not overwritten the next time a partial is committed and reconciled.

Stylesheets

As noted above, some embodiments of the invention use XML for high-level and low-level configurations. XSL is the stylesheet language of XML. It allows for the transformation of XML documents into other formats, such as HTML, or into other XML documents. A typical XSL consists of three parts:
XSLT, a language for transforming XML documents.
XPath, a language for addressing elements of an XML document.
   XSL Formatting Objects, a vocabulary for formatting XML documents.

Stylesheets are used as input to the configuration generator to transform high-level XML to low-level configuration XML.

Separate sets of stylesheets may need to be developed for each new product or product group (for example, POTS products). This may be achieved by creating additional stylesheets and referencing them in the product-specific stylesheet. The complexity of a stylesheet depends on the level of information contained within the configuration items.

In some embodiments, XML objects link to other external resources for information through a URI (Uniform Resource Identifier). A URI is an extension of a URL (Uniform Resource Locator) that conceptually encompasses other identifier schemes such as ISBN book numbers and international telephone numbers. The URL scheme is still the most commonly used resource location. Some embodiments of the invention use a narrower implementation of the URI. The URI provides for the

Confrep URI Resolver

A URI specified as a resource during the transformation process must be resolved to an XML source object. The URI implementation used in some embodiments of the invention is called confrep, and represents the root of a configuration repository. Text appearing after “confrep:/” represents a location relative to the root of the repository. As result, references are typically in a human interpretable format. Furthermore, because references are relative to the root, namespace conflicts with other repositories can be avoided.

A URI can be specified as the value of a href attribute (locator attribute) as follows:

<xsl:include href=“confrep:/
csadmin/transform/products/productSpecific.xsl”/>

A URI can also be referenced by the XML document within a <xsl:import> element.
Accessing Other Configuration Items

In some embodiments using stylesheets, the confrep URI allows references to other items in the Configuration Server. For example, an XSLT document( ) function could use the following confrep URI:

document(“confrep:/ci/PEzyStarter.xml”)

This XSL example searches the Configuration Server for the XML file PEzyStarter.xml. It then builds an XML document (or node tree) from the retrieved file. The document can be assigned to a variable and any data required extracted from it, through the use of XPath expressions.

Another way to use the confrep URI is:

confrep:/ci/PEzyStarter.xml

This example searches the Configuration Server for the XML file PEzystarter.xml. It is a reference only with no interrogation of the contents of the file. The transformer would then drill down into the contents of the file during the generation process.

?Old Suffix

In some embodiments, the previous version of a configuration item can be retrieved from the Configuration Server by using a suffix of ?old in the confrep URI; for example:
document(“confrep:/cs/PEzyStarter.XML?old”)

Exemplary high-level and low-level configurations are provided in Appendix A and Appendix B respectively.

As noted above, the update of a configuration item may require updates in multiple OSS components 108. Often, the order that the OSS components are updated may be important. For example, in the case of provisioning OSS components and billing OSS components, the provisioning system must first be updated in order to provision a product before the product is billed to a customer. In some embodiments of the invention, the configuration includes rules that may be used to specify an order for updates. In some embodiments, the update order to use is selected based on whether items match particular regular expressions. In alternative embodiments of the invention, the update order used is selected based on whether items mach particular XPath expressions. In further alternative embodiments of the invention, the configuration item type (e.g. an XML type) may be used in the configuration rules to determine update order. In still further alternative embodiments, the configuration rules cause the configuration server to examine the content of the configuration item to determine the update order. An example that includes an XML type and name for selection will now be described. In the example, a regular expression is provided for matching purposes. In the exemplary XML provided below, there are two different orders used (which correspond to the group elements). Type specifies an item type, and identifier specifies the item name using a regular expression. However, as noted above, an XPath pattern may also be used to specify the item name. In the example, if the item type is “AAAA and the item name matches the regular expression “w*AA”, then the order of update is the CB system followed by the CM system. For items having a type of BBBB or CCCC, the CM system is updated.

```
<?xml version=‘1.0’ encoding=‘UTF-8’?>
<ordering>
    <group>
        <order>
            <system>CB</system>
            <system>CM</system>
        </order>
        <items>
            <item>
                <type>AAAA</type>
                <identifier>\\w*AA\\w*</identifier>
            </item>
        </items>
    </group>
    <group>
        <order>
            <system>CM</system>
        </order>
        <items>
            <item>
                <type>BBBB</type>
            </item>
            <item>
                <type>CCCC</type>
            </item>
        </items>
    </group>
</ordering>
```

### Conclusion

Systems and methods for managing the configuration of an OSS and OSS components have been described. The systems and methods described provide advantages over previous systems.

Although specific embodiments have been illustrated and described herein, it will be appreciated by those of ordinary skill in the art that any arrangement which is calculated to achieve the same purpose may be substituted for the specific embodiments shown. For example, the systems and methods described may be applied to a Business Support System (BSS) as well as an OSS. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

1. A method for managing a configuration for a plurality of OSS components, the method comprising:
receiving a high level configuration, the high level configuration including a plurality of high level configuration items;
translating the high level configuration to a low level configuration, the low level configuration including a plurality of low level configuration items;
translating the low level configuration to at least one OSS component specific configuration; and
sending the at least one OSS component specific configuration to at least one OSS component.

2. The method of claim 1, wherein the high level configuration substantially conforms to a version of XML.

3. The method of claim 2, wherein translating the high level configuration to a low level configuration includes applying an XML style sheet to the high level configuration.

4. The method of claim 1, wherein the low level configuration substantially conforms to a version of XML.

5. The method of claim 1, wherein each of the plurality of configuration items is identified by an identifier relative to a configuration root.

6. The method of claim 5, wherein the identifier is a URI.

7. The method of claim 1, wherein the high level configuration includes ordering rules defining an order for updating the plurality of OSS components and wherein the OSS specific configuration is sent in accordance with the ordering rules.

8. The method of claim 1, wherein each of the plurality of configuration items have a configuration type and wherein the order for updating the plurality of OSS components is determined based on the configuration type.

9. The method of claim 1, wherein translating the high level configuration to a low level configuration includes:
generating a set of partial configuration items;
reconciling the set of partial configuration items against previously generated configuration items; and
merging the reconciled set of partial configuration items with the low level configuration items to form a set of full item definitions.

10. The method of claim 1, wherein translating the high-level configuration to a low-level configuration includes mapping a set of high-level configuration items to a set of low-level configuration items.

11. The method of claim 1, wherein translating the high-level configuration to a low-level configuration includes filtering the set of high-level configuration items such that the filtered configuration items are not part of the set of low-level configuration items.

12. The method of claim 1, wherein the high-level configuration items represent an abstracted set of data elements for a set of OSS components and wherein the low-level configuration items represent a set of OSS-specific data elements.

13. A system for managing a configuration for a plurality of OSS components, the system comprising:
a version control system having a version repository operable to maintain a high-level configuration having a plurality of high-level configuration items, each of said high-level configuration and high-level configuration items having a version; and
a configuration server operable to receive a version of the high-level configuration and high-level configuration items for storage in a configuration database, wherein the configuration server is operable to:
translate the high level configuration to a low level configuration, the low level configuration including a plurality of low level configuration items;
translate the low level configuration to at least one OSS component specific configuration; and
send the at least one OSS component specific configuration to at least one OSS component.
